(19) United States
(12) Patent Application Publication
(10) Pub. No.: US 2025/0164942 A1
(43) Pub. Date: May 22, 2025

(54) METHOD FOR CONTROLLING A MACHINE BY MEANS OF A LEARNING-BASED CONTROL AGENT, AND CONTROLLER

(71) Applicant: Siemens Aktiengesellschaft, München (DE)

(72) Inventors: Phillip Swazinna, Neufahrn (DE); Steffen Udluft, Eichenau (DE); Thomas Runkler, München (DE)

(21) Appl. No.: 18/839,631

(22) PCT Filed: Jan. 30, 2023
(86) PCT No.: PCT/EP2023/052164

§ 371 Date: Aug. 19, 2024

(30) Foreign Application Priority Data
Feb. 28, 2022 (EP) 22159152.2

(51) Int. Cl. G05B 13/02

(52) U.S. Cl. CPC G05B 13/027

(57) ABSTRACT

A method for controlling a machine, a performance evaluator and an action evaluator are provided. The performance evaluator ascertains the performance of the machine using a control signal while the action evaluator ascertains a deviation from a specified control sequence. Weighting values are generated in order to weight the performance with respect to the deviation. The weighting values and a plurality of states signals are fed into the control agent, and a respective resulting output signal of the control agent is fed into the performance evaluator and the action evaluator as a control signal. In accordance with the respective weighting value, a performance ascertained by the performance evaluator is weighted using a target function with respect to a deviation ascertained by the action evaluator. The control agent is thus trained to output a control signal which optimizes the target function using a state signal and a weighting value.

### CROSS-REFERENCE TO RELATED APPLICATIONS

This application is a national stage of PCT Application No. PCT/EP2023/052164, having a filing date of Jan. 30, 2023, claiming priority to EP Application Serial No. 22159152.2, having a filing date of Feb. 28, 2022, the entire both contents of which are hereby incorporated by reference.

### FIELD OF TECHNOLOGY

The following relates to a method for controlling a machine by a learning-based control agent, and controller.

### BACKGROUND

Data-driven machine learning methods, in particular reinforcement learning methods, are being increasingly used to control complex technical systems, for example robots, motors, manufacturing plants, energy supply devices, gas turbines, wind turbines, steam turbines, milling machines or other machines. In this case, control agents, in particular artificial neural networks, are trained, on the basis of a large quantity of training data, to generate a control signal for controlling the technical system, which signal is optimized with regard to a predefined target function, for a respective state of the technical system. Such a control agent trained to control a technical system is often also referred to as a policy or an agent for short.

The target function can evaluate, in particular, a performance to be optimized, for example a power, an efficiency, a resource consumption, a yield, a pollutant emission, a product quality and/or other operating parameters of the technical system. Such a target function is often also referred to as a reward function, a cost function or a loss function.

Such a performance-optimizing control agent can be used to significantly increase the performance of a technical system controlled thereby in many cases. Nevertheless, the prolific use of such a control agent also entails risks because the control signals generated have often not been tried and tested and are therefore possibly unreliable. This applies, in particular, under operating conditions which are not sufficiently covered by the training data. In addition, a user is often less familiar with a control sequence optimized in this manner and can therefore use his expertise to a lesser extent in order to monitor the correct behavior of the technical system.

### SUMMARY

An aspect of embodiments of the present invention is to specify a method and a controller for controlling a machine by a learning-based control agent, which allow more efficient and/or more reliable control.

In order to control a machine by a learning-based control agent, a performance evaluator and an action evaluator are provided. The performance evaluator uses a control signal to determine a performance for controlling the machine by the control signal, and the action evaluator uses the control signal to determine a deviation from a predefined control sequence. Furthermore, a multiplicity of weight values for weighting the performance with respect to the deviation are generated. The weight values and a multiplicity of state signals are fed into the control agent, wherein
a respectively resulting output signal from the control agent is fed as a control signal into the performance evaluator and into the action evaluator,
a performance respectively determined by the performance evaluator is weighted with respect to a deviation respectively determined by the action evaluator by a target function according to the respective weight value, and
the control agent is trained to use a state signal and a weight value to output a control signal optimizing the target function. In order to control the machine, an operating weight value and an operating state signal from the machine are then fed into the trained control agent, and a resulting output signal from the trained control agent is supplied to the machine.

A corresponding controller, a computer program product (non-transitory computer readable, non-volatile storage medium having instructions, which when executed by a processor, perform actions) are provided for carrying out the method according to embodiments of the invention.

In embodiments of the invention, the method and the controller according to embodiments of the invention may be carried out and implemented, respectively, by one or more computers, processors, application-specific integrated circuits (ASIC), digital signal processors (DSP) and/or so-called “Field Programmable Gate Arrays” (FPGA), for example.

Embodiments of the invention can be seen in the fact that various control strategies, which are optimized for different weightings of a performance with respect to a deviation from a predefined control sequence, can be set by simply inputting or changing an operating weight value during ongoing operation of the machine. In this manner, the trained control agent can be occasionally set during ongoing operation to give a proximity to the predefined control sequence a higher weighting than the performance of the machine. This may be, in particular, during safety-critical operating phases of the machine. In contrast, in less critical operating phases, the performance may be given a higher weighting than the proximity to the predefined control sequence, in order to accordingly favor performance optimization.

According to one embodiment of the invention, the weight value can be gradually changed when controlling the machine in such a manner that the performance is increasingly given a higher weighting with respect to the deviation. In particular, at the beginning of a control process, for example upon activation of the trained control agent or the machine, the deviation from the predefined control sequence may be initially given a higher weighting than the performance. This makes it possible to reduce an operating risk caused by control sequences that have not been tried and tested. If and to the extent that the control sequences then prove to be reliable, performance optimization can be gradually favored, and the performance can thus generally be increased.

According to a further embodiment of the invention, a respective performance can be determined by the performance evaluator and/or a respective deviation can be determined by the action evaluator on the basis of a respective state signal. The additional consideration of a state signal allows the respective performance and/or the respective deviation to be determined more accurately in many cases.

Furthermore, a performance value can be respectively read in for a multiplicity of state signals and control signals and quantifies a performance resulting from application of a respective control signal to a state of the machine specified by a respective state signal. The performance evaluator can then be trained to reproduce an associated performance value on the basis of a state signal and a control signal. This makes it possible to implement a performance evaluator using machine learning, in particular supervised learning, methods.

In addition, the performance evaluator can be trained to determine a performance accumulated over a future period of time by a Q-learning method and/or another Q-function-based reinforcement learning method. A multiplicity of efficient numerical optimization methods are available for carrying out Q-learning methods and Q-function-based methods.

According to a further embodiment of the invention, a multiplicity of state signals and control signals can be read in. The action evaluator can then be trained to use a state signal and a control signal to reproduce the control signal following information reduction, wherein a reproduction error is determined. The deviation can then be determined on the basis of the reproduction error. The preceding feature is based on the observation that reproduction errors are often smaller in state and control action ranges well covered by training data than in poorly covered ranges. The reproduction error can therefore be generally interpreted as a measure of the extent to which a respective state-specific control action is covered by the training data. If the training data are based on a predefined control sequence in many cases, the reproduction error can be used as a relatively accurate measure of the deviation from the predefined control sequence.

The deviation can be determined by the action evaluator by a variational autoencoder, by an autoencoder, by generative adversarial networks and/or by a comparison, in particular a state-signal-dependent comparison, with predefined control signals. A reduced-information and/or less redundant representation of state signals and/or control signals that have been fed in can be determined by using an autoencoder or in particular a variational autoencoder. In addition, a measure of how precisely the control signals, in particular, can be reconstructed again from the reduced variables can be determined in a simple manner. As already indicated above, reproducibility of control signals can be used as a measure of the deviation from a predefined control sequence.

Furthermore, a gradient-based optimization method, for example a gradient descent method, a stochastic optimization method, particle swarm optimization and/or a genetic optimization method can be used to train the control agent, the performance evaluator and/or the action evaluator. A multiplicity of efficient implementations are available for the methods mentioned.

### BRIEF DESCRIPTION

Some of the embodiments will be descripted in detail, with references to the following Figures, wherein like designations denote like members, wherein:

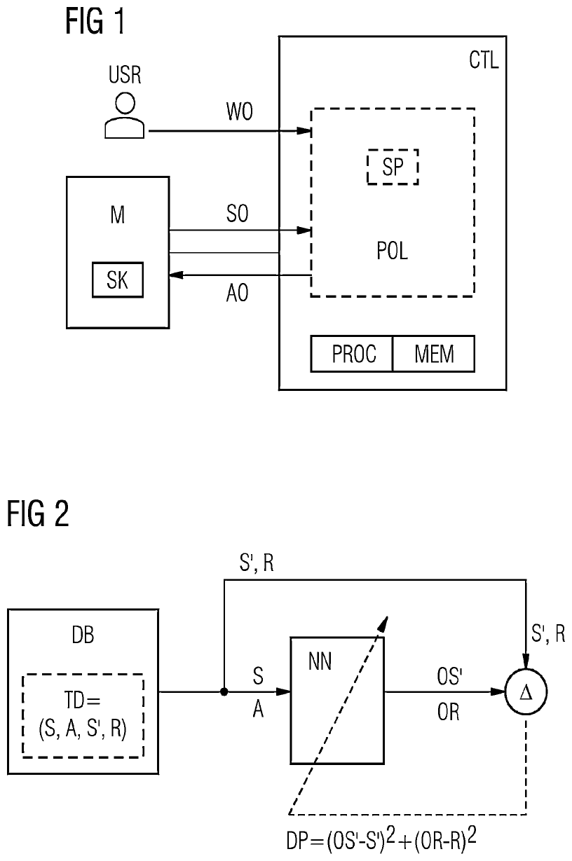

FIG. 1 shows a controller when controlling a machine,

FIG. 2 shows training of a transition model for determining performance,

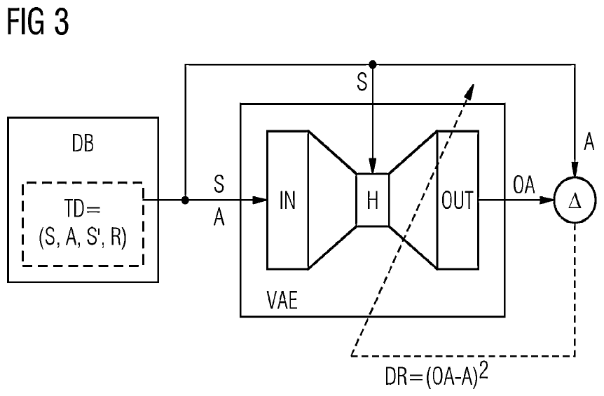

FIG. 3 shows training of an action evaluator, and

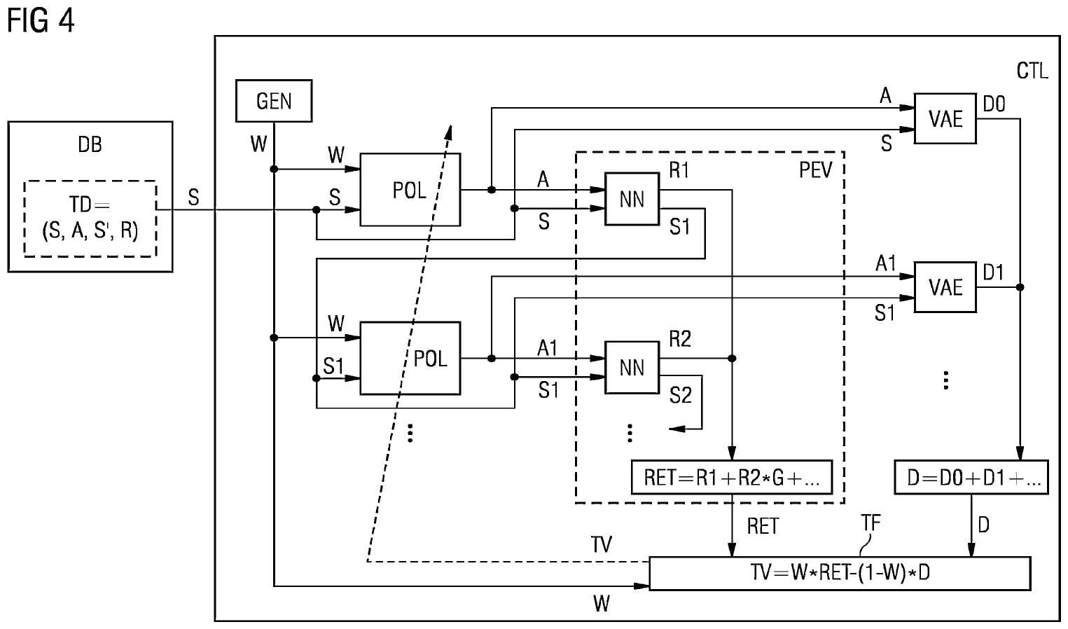

FIG. 4 shows training of a control agent of the controller.

If the same or corresponding reference signs are used in various figures, these reference signs denote the same or corresponding entities which may be implemented or configured, in particular, as described in connection with the relevant figure.

### DETAILED DESCRIPTION

FIG. 1 illustrates a controller CTL according to embodiments of the invention when controlling a machine M, for example a robot, a motor, a manufacturing plant, a factory, an energy supply device, a gas turbine, a wind turbine, a steam turbine, a milling machine or another device or another installation. In particular, a component or a subsystem of a machine or an installation can also be interpreted as a machine M.

The machine M has a sensor system SK for continuously capturing and/or measuring system states or subsystem states of the machine M.

The controller CTL is illustrated outside the machine M in FIG. 1 and is coupled to the machine. Alternatively, the controller CTL may also be completely or partially integrated in the machine M.

The controller CTL has one or more processors PROC for carrying out method steps of the controller CTL and one or more memories MEM which are coupled to the processor PROC and are intended to store the data to be processed by the controller CTL.

Furthermore, the controller CTL has a learning-based control agent POL which is trained or can be trained by reinforcement learning methods. Such a control agent is often also referred to as a policy or an agent for short. In the present exemplary embodiment, the control agent POL is implemented as an artificial neural network.

The control agent POL and therefore the controller CTL are trained in advance in a data-driven manner on the basis of predefined training data and are thus configured to control the machine M in an optimized manner. Optionally, the control agent POL may also be trained further during operation of the machine M, in which case state signals, control signals and/or performance data for the machine M in operation can be used as training data.

The training of the control agent POL is aimed, in particular, two control criteria. On the one hand, the machine M controlled by the control agent POL is intended to achieve the highest possible performance, whereas, on the other hand, the control process should not differ too greatly from a predefined control sequence SP. The performance may relate here to a power, an efficiency, a resource consumption, a yield, a pollutant emission, a product quality and/or other operating parameters of the machine M, for example.

A predefined control sequence SP may be specified, for example, by predefined sequences of states and/or control actions. In addition, a predefined control sequence SP may also be taken into account during training insofar as the training data come from the machine M, a machine similar to the latter or a simulation of the machine M, while this machine was controlled by a reference control agent. In this case, coverage of the states and/or control actions, which are run through by the machine M during control by the control agent POL, by the training data can be used as a criterion for a proximity of the control process to the reference control agent and therefore the predefined control sequence SP. A verified, validated and/or rule-based control agent can be used as the reference control agent.

According to embodiments of the invention, the control agent POL is intended to be trained in such a manner that a relative weighting of the two optimization criteria of performance and proximity to the predefined control sequence SP by a weight value can be changed during ongoing operation of the trained control agent POL. A sequence of this training is explained in more detail below.

In order to control the machine M in an optimized manner by the trained control agent POL, operating state signals SO, that is to say state signals determined during ongoing operation of the machine M, are transmitted to the controller CTL. The operating state signals SO each specify a state, in particular an operating state of the machine M, and are each represented by a numerical state vector or a time series of state values or state vectors.

Measurement data, sensor data, environmental data or other data arising during operation of the machine M or influencing operation can be represented by the operating state signals SO, for example data relating to a temperature, a pressure, a setting, an actuator position, a valve position, a pollutant emission, a utilization, a resource consumption and/or a power of the machine M or its components. In the case of a production plant, the operating state signals SO may also relate to a product quality or another product property. The operating state signals SO may be at least partially measured by the sensor system SK or determined by simulation by a simulator of the machine M.

Furthermore, an operating weight value WO is read in by the controller CTL, for example from a user USR of the machine M. The operating weight value WO is used to weight the performance of the machine M with respect to a deviation of the machine M, which is controlled by the control agent POL, from the predefined control sequence SP. Alternatively, the operating weight value WO may also be generated by the controller CTL on the basis of an operating condition or operating phase of the machine M.

The operating state signals SO transmitted to the controller CTL are fed into the trained control agent POL, together with the operating weight value WO, as input signals. The trained control agent POL generates a respective optimized operating control signal AO on the basis of a respectively supplied operating state signal SO and operating weight value WO. The optimized operating control signal here specifies one or more control actions that can be performed on the machine M. The generated operating control signals AO are transmitted from the control agent POL or the controller CTL to the machine M. The machine M is controlled in an optimized manner by the transmitted operating control signals AO by virtue of the control actions specified by the operating control signals AO being performed by the machine M.

The operating weight value WO can be used to occasionally set the trained control agent POL during ongoing operation of the machine M to give a proximity to the predefined control sequence SP a higher weighting than the performance of the machine M when determining optimized operating control signals AO. This may be, in particular, during safety-critical operating phases of the machine M. In contrast, in less critical operating phases, the performance can be given a higher weighting than the proximity to the predefined control sequence SP, in order to accordingly favor performance optimization.

In particular, at the beginning of a control process, for example upon activation of the trained control agent POL or the machine M, the proximity to the predefined control sequence SP can be initially given a higher weighting than the performance. This makes it possible to reduce an operating risk caused by control sequences that have not been tried and tested. If and to the extent that the control sequences then prove to be reliable, performance optimization can be gradually favored and the performance can thus generally be increased.

FIG. 2 illustrates training of a transition model NN for determining a performance of the machine M. The transition model NN is part of a performance evaluator PEV which is explained in more detail below.

The transition model NN can be trained in a data-driven manner and is intended to model a state transition when applying a control action to a predefined state of the machine M. Such a transition model is often also referred to as a dynamic model or system model. The transition model NN may be implemented in the controller CTL or completely or partially outside the latter. In the present exemplary embodiment, the transition model NN is implemented as an artificial neural network.

The transition model NN is intended to be trained, on the basis of training data sets TD contained in a database DB, to use a respective state and a respective control action to predict a subsequent state of the machine M resulting from application of the control action and a resulting performance value as accurately as possible.

In the present exemplary embodiment, the training data sets TD come from a control process of the machine M, a machine similar to the latter or a simulation of the machine M by a reference control agent. As already indicated above, the control processes carried out by the reference control agent are used, inter alia, to specify a predefined control sequence SP that is reflected in the training data sets TD.

The training data sets TD each comprise a state signal S, a control signal A, a subsequent state signal S′ and a performance value R. As already mentioned above, the state signals S each specify a state of the machine M and the control signals A each specify a control action that can be performed on the machine M. Accordingly, a respective subsequent state signal S′ specifies a subsequent state of the machine M resulting from application of the respective control action to the respective state. In particular, the same operating data relating to the machine M as specified by the aforementioned operating state signals SO can be specified by a state signal S and a subsequent state signal S′. The respectively associated performance value R finally quantifies a respective performance resulting from execution of the respective control action in the respective state. In this case, the performance value R may relate, in particular, to a currently resulting power, a currently resulting efficiency, a currently resulting resource consumption, a currently resulting yield, a currently resulting pollutant emission, a currently resulting product quality and/or other operating parameters of the machine M which result from performance of the current control action. In the context of machine learning, such a performance value is also referred to using the terms reward or—in a manner complementary to this-costs or loss.

In order to train the transition model NN, state signals S and control signals A are supplied to the transition model NN as input signals. The transition model NN is intended to be trained in such a manner that its output signals reproduce a respectively resulting subsequent state and a respectively resulting performance value as accurately as possible. Training is carried out using a supervised machine learning method.

Training should generally be understood here as meaning optimization of a mapping of input signals, here S and A, of a machine learning model, here NN, to its output signals. This mapping is optimized according to predefined or learned criteria and/or criteria to be learned during a training phase. Success of a control action in the case of control models or a prediction error in the case of prediction models can be used, in particular, as criteria. The training makes it possible to set or optimize networking structures of neurons in a neural network and/or weights of connections between the neurons, for example, in such a manner that the predefined criteria are satisfied as well as possible. The training can therefore be interpreted as an optimization problem. A multiplicity of efficient optimization methods are available for such optimization problems in the field of machine learning. Optimization should always also be understood as meaning an approach to an optimum.

Artificial neural networks, recurrent neural networks, convolutional neural networks, perceptrons, Bayesian neural networks, autoencoders, variational autoencoders, deep learning architectures, support vector machines, data-driven regression models, k-nearest neighbor classifiers, physical models or decision trees can be trained, in particular.

In the case of the transition model NN, state signals S and control signals A from the training data are supplied to the transition model as input signals, as already mentioned above. For a respective input data set (S, A) comprising a state signal S and a control signal A, the transition model NN outputs an output signal OS′ as a subsequent state signal and an output signal OR as a performance value.

The aim of the training of the transition model NN is for the output signals OS′ to correspond as well as possible, at least on average, to the actual subsequent state signals S′ and for the output signals OR to correspond as well as possible, at least on average, to the actual performance values R. A deviation DP between a respective output signal pair (OS′, OR) and the respectively corresponding pair (S′, R) contained in the training data is determined for this purpose. The deviation DP here represents a prediction error of the transition model NN. The deviation DP may be determined, for example, by calculating a Euclidean distance between the respective representing vectors, for example according to DP=(OS′−S′)²+ (OR−R)².

As indicated in FIG. 2 by a dashed arrow, the deviation DP is returned to the transition model NN. On the basis of the returned deviation DP, the transition model NN is trained to minimize this deviation DP and therefore the prediction error, at least on average. A multiplicity of efficient optimization methods, for example gradient-based optimization methods, stochastic gradient descent methods, particle swarm optimizations and/or genetic optimization methods, are available for minimizing the deviation DP. As a result of the minimization of the deviation DP, the transition model NN is trained to predict a resulting subsequent state and a resulting performance value as well as possible for a predefined state and a predefined control action.

FIG. 3 illustrates data-driven training of an action evaluator VAE. The action evaluator VAE may be implemented in the controller CTL or completely or partially outside the latter.

The action evaluator VAE is used to determine a deviation of a control process from a predefined control sequence SP and is implemented in the present exemplary embodiment by a variational autoencoder. As already mentioned above, the predefined control sequence SP is defined to a certain extent by the training data obtained by the reference control agent.

In the present exemplary embodiment, the variational autoencoder VAE is used to evaluate the reproducibility of a respective state-specific control action. This reproducibility proves to be a relatively accurate measure of a similarity of a respective state-specific control action to the control actions present in the training data or as a measure of a probability of occurring in the training data.

In the present exemplary embodiment, the variational autoencoder VAE is implemented as a feed-forward neural network and comprises an input layer IN, a hidden layer H and an output layer OUT. In addition to the hidden layer H, the variational autoencoder VAE may have further hidden layers. The characteristic of an autoencoder is that the hidden layer His significantly smaller, that is to say has fewer neurons, than the input layer IN or the output layer OUT.

The variational autoencoder VAE is intended to be trained, on the basis of training data sets TD read in from the database DB, to use state signals S and control signals A that have been read in to reproduce the control signals A that have been read in as accurately as possible, at least on average, following information reduction caused by the smaller hidden layer H. In this case, the intention is also to determine a reproduction error DR, in particular.

For this purpose, the state signals S and control signals A from the training data are fed into the input layer IN as input signals and are processed by the layers IN, H and OUT. The processed data are finally output by the output layer OUT as output signals OA that are intended to reproduce the control signals A that have been fed in as accurately as possible according to the training goal. State signals S are also supplied to the hidden layer H.

If the input signals, here S and A, must pass through the smaller hidden layer H to a certain extent and are intended to be able to be largely reconstructed again from the available, smaller or reduced quantity of data according to the training goal, a reduced-data representation of the input signals is obtained in the hidden layer H. In this manner, the variational autoencoder VAE learns efficient coding or compression of the input signals. Also feeding state signals S directly into the hidden layer H makes it possible to achieve the situation in which the control signals A, in particular, are coded or reduced or represented more effectively in the hidden layer H.

In the hidden layer H, a so-called latent parameter space or a latent representation, in particular of the control signals A or of the control actions specified by the latter, is achieved by the training. The data present in the hidden layer H correspond to an abstract and reduced-information representation of the state-specific control actions contained in the training data.

In order to achieve the above training goal, an optimization method is carried out, which optimization method sets processing parameters of the variational autoencoder VAE in such a manner that the reproduction error DR is minimized. In this case, a distance between the output signals OA and the control signals A which have been fed in can be determined, in particular, as the reproduction error or reproduction uncertainty DR according to DR=(OA−A)².

In order to train the variational autoencoder VAE or to optimize its processing parameters, the calculated distances DR are returned to the variational autoencoder VAE, as indicated by a dashed arrow in FIG. 3. In order to specifically carry out the training, it is possible to resort to a multiplicity of efficient standard methods.

After successful training, the trained variational autoencoder VAE can be used to evaluate any pair of a respective state signal S and a respective control signal A in order to determine how well the respective control signal A can be reconstructed from the reduced-information representation in the hidden layer H. It can be expected that state/control action pairs that frequently occur in the training data will have a smaller reproduction error DR than state/control action pairs that rarely occur in the training data. The reproduction error DR of the trained variational autoencoder VAE can therefore be used as a measure of how well a respective state/control action pair is covered by the training data or how often or how likely it occurs there or how greatly it deviates from the predefined control sequence SP.

FIG. 4 illustrates training of the control agent POL by the trained transition model NN and the trained action evaluator VAE. In order to illustrate successive work steps, a plurality of instances of the control agent POL, of the trained transition model NN and of the trained variational autoencoder VAE are each illustrated in FIG. 4. The various instances may correspond, in particular, to various calls or evaluations of routines that are used to implement the control agent POL, the trained transition model NN and/or the trained action evaluator VAE.

As already mentioned above, the control agent POL is intended to be trained to output, for a respective state signal S of the machine M, a control signal A which is optimized, on the one hand, with regard to a resulting performance of the machine M and, on the other hand, with regard to a proximity to or a deviation from the predefined control sequence SP. The proximity to the predefined control sequence SP can obviously also be represented by a negatively weighted deviation from the predefined control sequence SP and vice versa. Optimization is aimed at higher performance and greater proximity to or smaller deviation from the predefined control sequence SP. The weighting of the two optimization criteria of performance and proximity or deviation is intended to be able to be set by a weight value W.

For the present exemplary embodiment, it is assumed that the weight value W can be set between 0 and 1. In the case of a weight value of W=1, the trained control agent POL is intended to output a control signal solely optimizing performance, whereas, in the case of a weight value of W=0, a control signal solely minimizing the deviation from the predefined control sequence SP is intended to be output. In the case of weight values of between 0 and 1, the two optimization criteria are intended to be accordingly proportionately weighted.

In order to train the control agent POL for different weight values, a generator GEN of the controller CTL generates a multiplicity of weight values W in a randomized manner. In the present exemplary embodiment, the generated weight values W are in the range from 0 to 1.

According to embodiments of the invention, the weight values W generated by the generator GEN are fed both into the control agent POL to be trained and into a target function TF to be optimized by the training.

Furthermore, in order to train the control agent POL, state signals S from the database DB are fed in a large quantity into the control agent POL as input signals.

In parallel with this, the state signals S are also fed into the trained transition model NN and into the trained action evaluator VAE as input signals.

A respective state signal S respectively specifies a state of the machine M. The trained transition model NN uses the respective state to predict subsequent states of the machine M which result from application of control actions. In addition, the respective state and the resulting subsequent states are evaluated by the trained variational autoencoder VAE.

The control agent POL derives an output signal A from the respective state signal S and outputs it as a control signal. The control signal A is then fed, together with the respective state signal S, into the trained transition model NN which predicts a subsequent state therefrom and outputs a subsequent state signal S1 specifying this subsequent state and an associated performance value R1.

In addition, the control signal A is fed, together with the respective state signal S, into the trained variational autoencoder VAE which determines and outputs a reproduction error DO for the control signal A therefrom.

The subsequent state signal S1 is in turn fed into the control agent POL which derives a control signal A1 for the subsequent state therefrom. The control signal A1 is fed, together with the respective subsequent state signal S1, into the trained transition model NN which predicts a further subsequent state therefrom and outputs a subsequent state signal S2 specifying this subsequent state and an associated performance value R2.

In addition, the control signal A1 is fed, together with the subsequent state signal S1, into the trained variational autoencoder VAE which determines and outputs a reproduction error D1 for the control signal A1 therefrom.

As already mentioned above, the reproduction errors D0 and D1 can be used as a measure of a deviation of the control signals A and A1 from the predefined control sequence SP.

The above method steps can be iteratively repeated, wherein performance values and reproduction errors are determined for further subsequent states. The iteration can be ended when there is an abort condition, for example when a predefined number of iterations is exceeded. This makes it possible to determine a control trajectory, which comprises a plurality of time steps, advances from subsequent state to subsequent state and is extrapolated into the future, with associated performance values R1, R2, . . . and reproduction errors D0, D1, . . . . Such an extrapolation is often also referred to as roll-out or virtual roll-out.

The performance values R1, R2, . . . of a respective control trajectory are used to determine an overall performance RET of this control trajectory accumulated over a plurality of time steps. Such an accumulated overall performance is often also referred to as return in the context of reinforcement learning. The overall performance RET is assigned to the respective state signal S and/or control signal A at the start of the respective control trajectory and thus evaluates an ability of the control agent POL to determine, for the respective state signal S, a control signal A that initiates a control sequence that is performant over a plurality of time steps.

In order to determine the overall performance RET, the performance values R1, R2, determined for future time steps are discounted, that is to say are provided with weights that become smaller for each time step. In the present exemplary embodiment, the overall performance RET is calculated as a weighted sum of the performance values R1, R2, . . . , the weights of which are multiplied by a discounting factor G<1 with each time step in the future. This makes it possible to determine the overall performance RET according to RET=R1+R2*G+R3*G2+ . . . . A value of 0.99, 0.9, 0.8 or 0.5 can be used, for example, for the discounting factor G.

The transition model NN and the above discounting method together form a performance evaluator PEV which uses control signals A, A1, . . . and state signals S, S1, . . . to determine an overall performance RET of the machine M resulting from application of the control signals.

Alternatively or additionally, the performance evaluator PEV can also be implemented by a Q-learning method and can be trained to determine the overall performance RET accumulated over a future period of time.

Furthermore, an overall reproduction error D accumulated over a plurality of time steps is determined from the reproduction errors D0, D1, . . . of the respective control trajectory. The overall reproduction error is used, in the further method, as a measure of the deviation of this control trajectory from the predefined control sequence SP. In the present exemplary embodiment, the overall reproduction error D is determined as a sum of the individual reproduction errors D0, D1, . . . according to D=D1+D2+ . . . .

The respectively determined overall performance RET and the respectively determined overall reproduction error D are fed together into the target function TF to be optimized.

The target function TF weights the respectively determined overall performance RET and the respectively determined overall reproduction error D according to the same respective weight value W which was also fed into the control agent POL together with the respective state signal S. By training that optimizes the target function TF, the control agent POL can therefore be trained, when a state signal and a weight value are input, to output a control signal that optimizes the target function TF, at least on average, according to the weight value that has been input.

In the present exemplary embodiment, the target function TF determines a respective target value TV from a respective overall performance RET, a respective overall reproduction error D and a respective weight value W according to TV=W*RET−(1−W)*D. If the aim is for the control trajectory to be as close as possible to the predefined control sequence SP, the overall reproduction error D is included in the target value TV with a negative sign. If necessary, the overall performance RET and/or the overall reproduction error D can also be provided with a respectively constant normalization factor before calculating the target value TV.

The respectively determined target value TV is assigned to the respective state signal S and/or control signal A at the start of the respective control trajectory. The respective target value TV thus evaluates a current ability of the control agent POL to initiate, for the respective state signal S, a control sequence that both optimizes performance and is close to the predefined control sequence SP according to the weight value W.

In order to train the control agent POL, that is to say in order to optimize its processing parameters, the determined target values TV are returned to the control agent POL, as indicated by a dashed arrow in FIG. 4. The processing parameters of the control agent POL are set or configured in such a manner that the target values TV are maximized, at least on average. In order to specifically implement the training, it is possible to resort to a multiplicity of efficient standard methods, in particular reinforcement learning methods.

After successful training of the control agent POL, the latter can be used to control the machine M in an optimized manner, as described in connection with FIG. 1. In this case, the weighting of the optimization criteria of performance and proximity to the predefined control sequence SP can be easily set and changed during ongoing operation. In this manner, depending on the operating requirement or operating phase, the control of the machine M can be adjusted to whether the performance or the reliability is intended to be given a higher weighting.

Although the present invention has been disclosed in the form of embodiments and variations thereon, it will be understood that numerous additional modifications and variations could be made thereto without departing from the scope of the invention.

For the sake of clarity, it is to be understood that the use of “a” and “an” throughout this application does not exclude a plurality, and “comprising” does not exclude other steps or elements.

1. A computer-implemented method for controlling a machine by a learning-based control agent, comprising:
a) providing a performance evaluator and using a control signal to determine a performance for controlling the machine by the control signal,
b) providing an action evaluator and using the control signal to determine a deviation from a predefined control sequence,
c) weighting a multiplicity of weight values for the performance with respect to the deviation are generated,
d) feeding a multiplicity of state signals and the weight values into the control agent, wherein
feeding a respectively resulting output signal from the control agent as a control signal into the performance evaluator and into the action evaluator,
weighting a performance respectively determined by the performance evaluator with respect to a deviation respectively determined by the action evaluator by a target function according to the respective weight value, and
outputting the control agent is trained to use a state signal and a weight value a control signal optimizing the target function, and
e) in order to control the machine
feeding an operating weight value and an operating state signal from the machine into the trained control agent, and
supplying a resulting output signal from the trained control agent to the machine.

2. The method as claimed in claim 1, wherein
the weight value is gradually changed when controlling the machine in such a manner that the performance is increasingly given a higher weighting with respect to the deviation.

3. The method as claimed claim 1,
wherein a respective performance is determined by the performance evaluator and/or a respective deviation is determined by the action evaluator on the basis of a respective state signal.

4. The method as claimed in
claim 1 wherein a performance value is respectively read in for a multiplicity of state signals and control signals and quantifies a performance resulting from application of a respective control signal to a state of the machine specified by a respective state signal, in that the performance evaluator is trained to reproduce an associated performance value on the basis of a state signal and a control signal.

5. The method as claimed in claim 1, wherein the performance evaluator is trained to determine a performance accumulated over a future period of time by a Q-learning method and/or another Q-function-based reinforcement learning method.

6. The method as claimed in claim 1,
wherein a multiplicity of state signals and control signals are read in,
in that the action evaluator is trained to use a state signal and a control signal to reproduce the control signal following information reduction, wherein a reproduction error is determined, and
in that the deviation is determined on the basis of the reproduction error.

7. The method as claimed in claim 1,
wherein the deviation is determined by the action evaluator by a variational autoencoder, by an autoencoder, by generative adversarial networks and/or by a comparison, a state-signal-dependent comparison, with predefined control signals.

8. The method as claimed in claim 1,
wherein the weight values are generated in a randomized manner.

9. The method as claimed in claim 1, wherein
a gradient-based optimization method, a stochastic optimization method, particle swarm optimization and/or a genetic optimization method is/are used to train the control agent, the performance evaluator and/or the action evaluator.

10. The method as claimed in claim 1,
wherein the control agent, the performance evaluator and/or the action evaluator comprise an artificial neural network, a recurrent neural network, a convolutional neural network, a multilayer perceptron, a Bayesian neural network, an autoencoder, a variational autoencoder, a deep learning architecture, a support vector machine, a data-driven trainable regression model, a k-nearest neighbor classifier, a physical model and/or a decision tree.

11. The method as claimed in claim 1,
wherein the machine is a robot, a motor, a manufacturing plant, a factory, an energy supply device, a gas turbine, a wind turbine, a steam turbine, a milling machine or another device or another installation.

12. A controller for controlling a machine, configured to carry out a method as claimed in claim 1.

13. A computer program product, comprising a computer readable hardware storage device having computer readable program code stored therein, said program code executable by a processor of a computer system to implement a method as claimed in claim 1.

14. A computer-readable storage medium having a computer program product as claimed in claim 13.
